(19) United States
(12) Patent Application Publication
(10) Pub. No.: US 2020/0234263 A1
(43) Pub. Date: Jul. 23, 2020

(54) Method of Selling Items through a Multi-sided Vending Machine and Related Device

(71) Applicant: LEADOT INNOVATION, INC., KAOHSIUNG (TW)

(72) Inventor: Justin Wang, Taipei City (TW)

(21) Appl. No.: 16/254,483

(22) Filed: Jan. 22, 2019

(51) Int. Cl. G06Q 20/20; G07F 17/00; G06Q 30/02

(52) U.S. Cl. CPC G06Q 20/201; G06Q 30/0268; G07F 17/0014

(57) ABSTRACT

A multi-sided vending machine uses multiple sides of the multi-sided vending machine for selling items. The multi-sided vending machine contains a product storage compartment storing items for sale, a plurality of displays, a plurality of money acceptors, and a plurality of dispensing slots for selling items on different sides of the multi-sided vending machine. A controller of the multi-sided vending machine operates a motor that turns a rotatable ramp toward any of the different sides of the multi-sided vending machine. When a selected item is purchased from a selected side of the multi-sided vending machine, the controller controls the product storage compartment to release the selected item, and controls the motor to turn the rotatable ramp toward the selected side for guiding the selected item to the dispensing slot on the selected side.

### BACKGROUND OF THE INVENTION

### 1. Field of the Invention

The invention relates to vending machines, and more particularly, to a multi-sided vending machine capable of selling items from each of a plurality of sides of the vending machine.

### 2. Description of the Prior Art

Vending machines are widely used now for selling items such as bottled drinks, canned drinks, cookies, candy, chips, coffee, and even non-food items such as tickets. Traditional vending machines use only one side of the vending machine for interacting with the customer. For instance, the front of the vending machine is used for displaying the products for sale, for accepting payment from the customer, and for dispensing the sold product to the customer. While traditional vending machines do allow the customer to purchase items from the vending machine, only one side of the vending machine is used for selling products to customers. Other sides of the vending machine such as the left side or the right side of the vending machine with respect to the front of the vending machine are left unused and often do not serve to fully promote the products being sold in the vending machine. Furthermore, if the vending machine is selling a popular product at a busy time, there may be a line of people waiting to use the vending machine. Thus, selling products through only one single side of the vending machine causes inconvenience to potential customers of the vending machine, and may force potential customers to decide not to make a purchase at that time due to the long lines associated with the vending machines. Thus, traditional vending machines would benefit from a design that would allow multiple customers to be served at the same time.

### SUMMARY OF THE INVENTION

It is therefore one of the primary objectives of the claimed invention to provide a multi-sided vending machine for overcoming limitations with traditional vending machines.

According to an exemplary embodiment of the claimed invention, a multi-sided vending machine is disclosed. The multi-sided vending machine includes a housing; a product storage compartment disposed within the housing, the product storage compartment storing items for sale; a plurality of displays disposed outside the housing, each display of the plurality of displays being located on a different side of the housing, wherein the displays show images corresponding to the items for sale; a user interface receiving instructions from a customer to purchase a selected item of the items for sale through a selected side of the multi-sided vending machine; a plurality of money acceptors, each money acceptor of the plurality of money acceptors being located on a different side of the housing, a money acceptor of the plurality of money acceptors located on the selected side receiving money used to pay for the selected item; a plurality of dispensing slots, each dispensing slot of the plurality of dispensing slots being located on a different side of the housing, wherein a dispensing slot of the plurality of dispensing slots located on the selected side dispenses the selected item to the customer after the selected item is purchased; a rotatable ramp disposed within the housing above the plurality of dispensing slots and rotatable toward any of the different sides of the housing, the rotatable ramp rotating toward the selected side and guiding the selected item into the dispensing slot located on the selected side; a motor turning the rotatable ramp toward the selected side when the selected item is purchased from the selected side; and a controller controlling operation of the multi-sided vending machine, controlling the motor to turn the rotatable ramp toward the selected side, and controlling the product storage compartment to release the selected item when the selected item is purchased from the selected side.

According to another exemplary embodiment of the claimed invention, a method of selling items for sale through a multi-sided vending machine is disclosed. The method includes receiving, through a user interface of the multi-sided vending machine, instructions from a customer to purchase a selected item of items for sale through a selected side of the multi-sided vending machine, the multi-sided vending machine comprising: a housing; a product storage compartment disposed within the housing, the product storage compartment storing the items for sale; a plurality of displays disposed outside the housing, each display of the plurality of displays being located on a different side of the housing, wherein the displays show images corresponding to the items for sale; a plurality of money acceptors, each money acceptor of the plurality of money acceptors being located on a different side of the housing, a money acceptor of the plurality of money acceptors located on the selected side receiving money used to pay for the selected item; a plurality of dispensing slots, each dispensing slot of the plurality of dispensing slots being located on a different side of the housing, wherein a dispensing slot of the plurality of dispensing slots located on the selected side dispenses the selected item to the customer after the selected item is purchased; a rotatable ramp disposed within the housing above the plurality of dispensing slots and rotatable toward any of the different sides of the housing, the rotatable ramp rotating toward the selected side and guiding the selected item into the dispensing slot located on the selected side; and a motor turning the rotatable ramp toward the selected side when the selected item is purchased from the selected side. The method includes controlling the motor to turn the rotatable ramp toward the selected side and controlling the product storage compartment to release the selected item onto the rotatable ramp and down the dispensing slot located on the selected side when the selected item is purchased from the selected side.

It is an advantage that the present invention uses more than one side of the vending machine for displaying and selling products. The multi-sided vending machine allows sellers to use more area of the vending machine for displaying products being sold. Furthermore, a larger number of different items can potentially be sold through the multi-sided vending machine since more products can be displayed on the different sides of the multi-sided vending machine compared to just using a single side. Multiple customers can also buy products from the multi-sided vending machine at the same time since different customers can interact with the multi-sided vending machine for making purchases simultaneously through different sides of the multi-sided vending machine. This can reduce the wait experienced by potential customers and shorten the lines of people waiting to make a purchase through the multi-sided vending machine. Thus, multi-sided vending machines can increase sales while at the same time not requiring an increased footprint for area needed to install the multi-sided vending machine.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a perspective diagram of a multi-sided vending machine showing items for sale according to the present invention.

FIG. 2 illustrates a perspective diagram of the multi-sided vending machine showing advertisements according to the present invention.

FIG. 3 is a functional block diagram of the multi-sided vending machine according to the present invention.

FIG. 4 is a diagram showing internal components of the multi-sided vending machine.

FIG. 5 is a diagram showing a touch panel being overlaid on a display panel.

FIG. 6 illustrates creating a display panel of the plurality of display panels by joining many smaller displays together.

FIG. 7 illustrates rotating multiple display panels of the plurality of display panels toward a same side in order to create a larger advertising space with the display panels.

FIG. 8 illustrates a multi-sided vending machine having a cylindrical shape according to another embodiment of the present invention.

FIG. 9 illustrates a multi-sided vending machine having a hexagonal prism shape according to yet another embodiment of the present invention.

### DETAILED DESCRIPTION

The present invention improves upon traditional vending machines by using a plurality of sides of the vending machine for selling products in order to create a multi-sided vending machine.

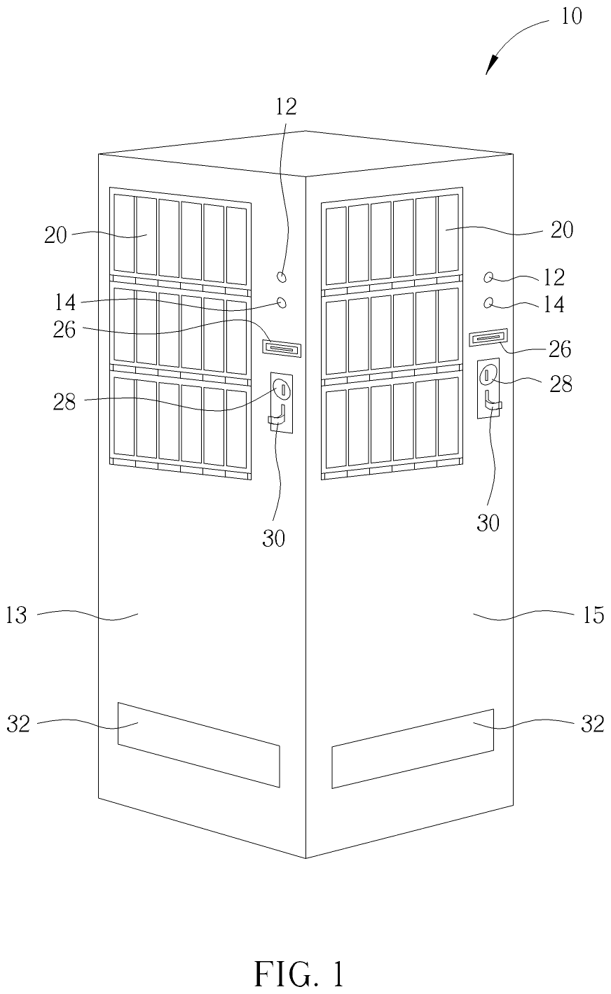

Please refer to FIG. 1. FIG. 1 illustrates a perspective diagram of a multi-sided vending machine 10 showing items for sale according to the present invention. The multi-sided vending machine 10 can be any three-dimensional shape having more than one side, and is depicted in FIG. 1 as being a rectangular prism having six sides including a front side, a left side, a rear side, a right side, a top side, and a bottom side. More than one side of the multi-sided vending machine 10 can be used for selling items simultaneously. For example, assume that a front side 13 and a right side 15 of the multi-sided vending machine 10 are the sides depicted in FIG. 1. The items shown as being for sale on the front side 13 can be different from the items shown as being for sale on the right side 15. This means that customers can see and purchase different items on the front side 13 than what the customers can see and purchase on the right side 15. Please note that other sides of the multi-sided vending machine 10 can also be used for selling items, and the rear side and the left side of the multi-sided vending machine 10 can easily be used for displaying and selling the same items or different items than what are shown in the front side 13 and the right side 15.

Each of the sides of the multi-sided vending machine 10 that are being used for selling items can contain similar or identical elements in order to facilitate sales on those sides. As shown in FIG. 1, the multi-sided vending machine 10 comprises a plurality of proximity sensors 12 and a plurality of cameras 14. The present invention multi-sided vending machine 10 can make use of either the proximity sensors 12 or the cameras 14, or can use a combination of the proximity sensors 12 and the cameras 14 for sensing when a customer approaches the multi-sided vending machine 10. This feature will be explained below.

The multi-sided vending machine 10 comprises a plurality of display panels 20 disposed on outer surfaces of different sides of the multi-sided vending machine 10. As shown in FIG. 1, the display panels 20 show images corresponding to the items for sale on the corresponding sides of the multi-sided vending machine 10. A plurality of bill acceptors 26 and a plurality of coin acceptors 28 are also disposed on outer surfaces of different sides of the multi-sided vending machine 10 for accepting payment from customers for items for sale on the corresponding sides of the multi-sided vending machine 10. A plurality of dispensing slots 32 disposed on outer surfaces of different sides of the multi-sided vending machine 10 are used for dispensing purchased items to the customer after the customer makes a purchase on the corresponding side of the multi-sided vending machine 10. For instance, if the customer sees an item for sale on the display panel 20 of the front side 13, the customer will select an item, insert money into the bill acceptor 26 and/or the coin acceptor 28 on the front side 13 for purchasing the selected item, and will then receive the selected item from the dispensing slot 32 on the front side 13. A plurality of coin return slots 30 can also be disposed on different sides of the multi-sided vending machine 10 for returning coins to the customer, as is well known by a person of ordinary skill in the art of vending machines.

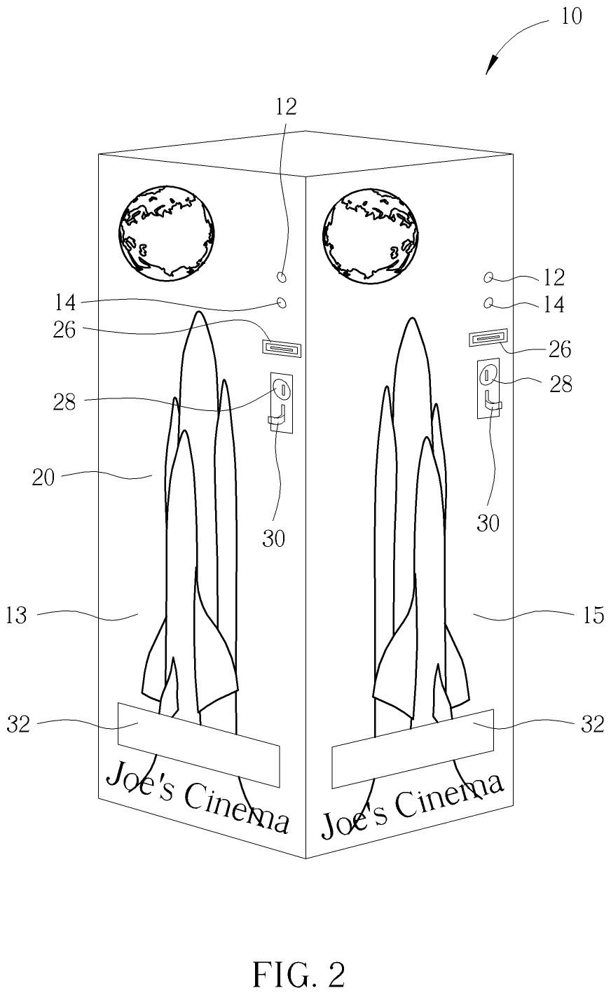

Please refer to FIG. 1 and FIG. 2. FIG. 2 illustrates a perspective diagram of the multi-sided vending machine 10 showing advertisements according to the present invention. When the proximity sensors 12 and the cameras 14 detect that a customer is nearby the multi-sided vending machine 10, the display panels 20 show items for sale, as shown in FIG. 1. The cameras 14 can be realized using video cameras that are always on for detecting when customers approach the multi-sided vending machine 10. When the proximity sensors 12 and the cameras 14 detect that a customer is not located nearby the multi-sided vending machine 10, the display panels 20 can be used for displaying advertisements, such as what is depicted in FIG. 2. The advertisements are optional, and if the advertisements are not used, then the proximity sensors 12 and the cameras 14 are also not necessary for the multi-sided vending machine 10, and the display panels can constantly show the items for sale. However, using the display panels 20 of the multi-sided vending machine 10 for advertising can greatly increase the revenue stream of the operator of the multi-sided vending machine 10. In short, the display panels 20 can switchback and forth between showing items for sale and showing advertisements, depending on whether a customer is detected as being nearby the multi-sided vending machine 10.

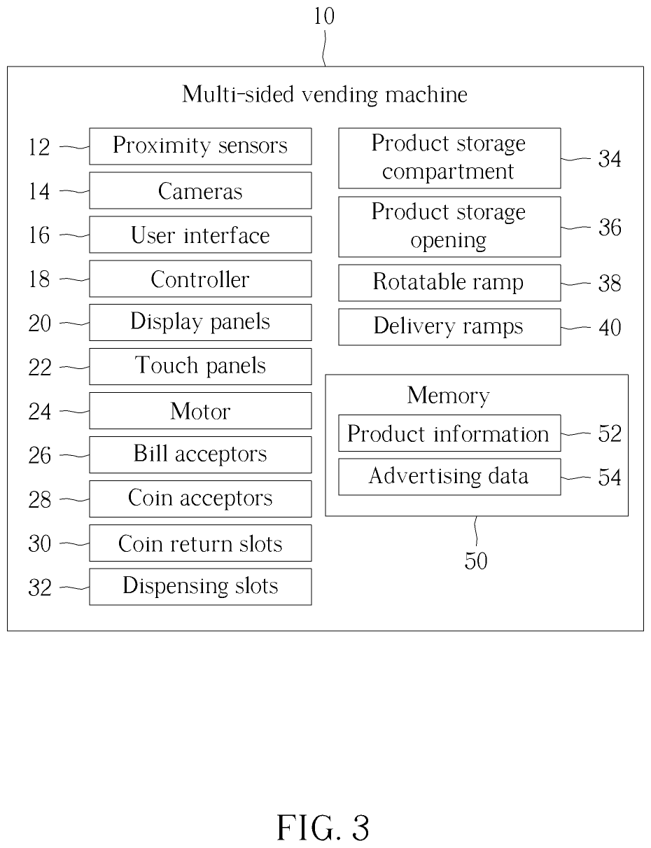

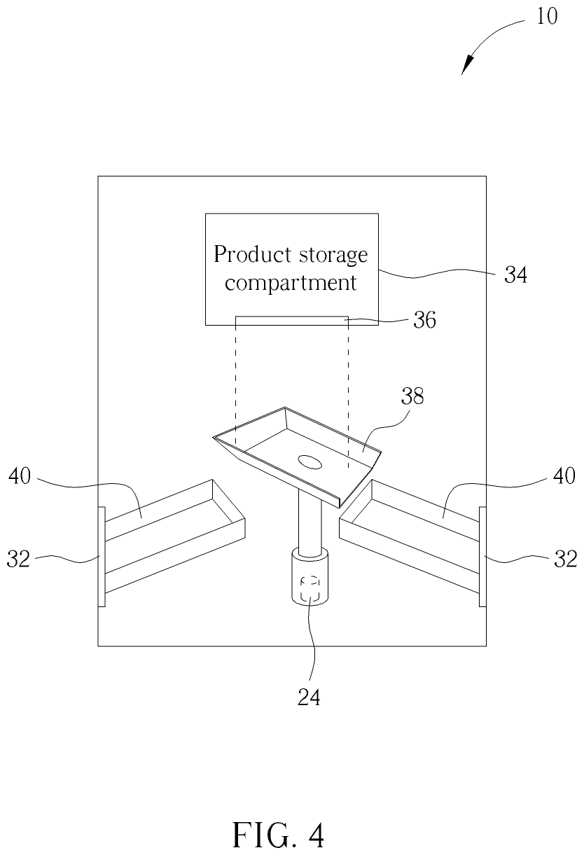

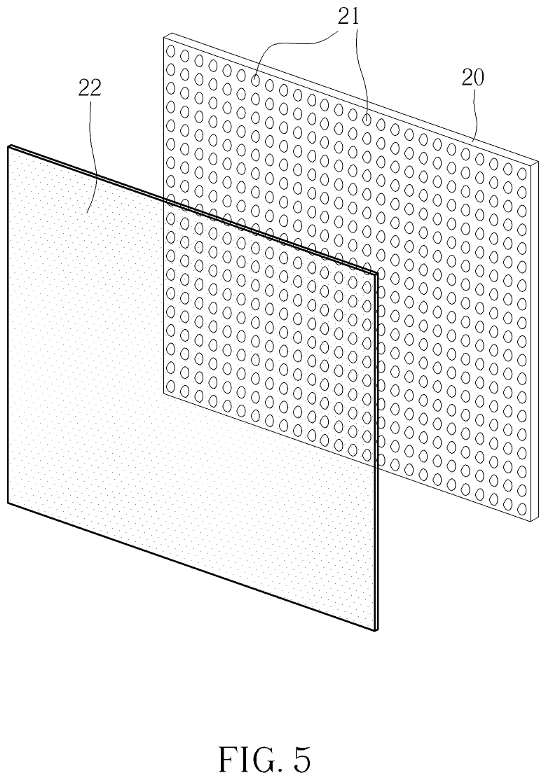

Please refer to FIG. 3, FIG. 4, and FIG. 5. FIG. 3 is a functional block diagram of the multi-sided vending machine 10 according to the present invention. The proximity sensors 12, the cameras 14, the display panels 20, the bill acceptors 26, the coin acceptors 28, and the coin return slots 30 of the multi-sided vending machine 10 have previously been described. FIG. 4 is a diagram showing internal components of the multi-sided vending machine 10. FIG. 5 is a diagram showing a touch panel 22 being overlaid on a display panel 20. The use of touch panels 22 laid over the display panels 20 allows the customer to make selections of items to purchase by touching the touch panels 22. If an item is shown on a certain part of one of the display panels 20, the customer can simply touch an item in order to select the item and begin the process of purchasing the selected item. The display panels 20 may be light-emitting diode (LED) arrays containing two-dimensional arrays of LEDs 21. Each of the display panels 20 may also be other types of displays, such as an organic light-emitting diode (OLED) display or a liquid crystal display (LCD).

As shown in FIG. 4, a product storage compartment 34 is disposed within the multi-sided vending machine 10 and contains items for sale, and the product storage compartment 34 contains a product storage opening 36 for releasing selected items when the selected items are purchased through the multi-sided vending machine 10. The multi-sided vending machine 10 contains a user interface 16 for receiving input from the customer via the touch panels 22 and for interacting with the customer through the display panels 20. A controller 18 receives input from the user interface 16 and the touch panels 22 regarding the selected item that the customer wishes to purchase and regarding the selected side of the multi-sided vending machine 10 that the customer wishes to purchase from, and controls the product storage compartment 34 to output the selected item through the product storage opening 36 on the selected side. The controller 18 also controls a motor 24 to turn a rotatable ramp 38 toward the selected side when the selected item is purchased from the selected side. The rotatable ramp 38 is disposed within the multi-sided vending machine 10 above the dispensing slots 32, and the rotatable ramp 38 is rotatable toward any of the different sides of the multi-sided vending machine 10. The multi-sided vending machine 10 further includes a plurality of delivery ramps 40 that are disposed below the rotatable ramp 38 and above the dispensing slots 32. When the customer purchases the selected item from the selected side, the controller 18 controls the motor 24 to turn the rotatable ramp 38 toward the selected side. The controller 18 then controls the product storage compartment 34 to open the product storage opening 36 to release the selected item. The selected item then falls from the product storage compartment 34 into the rotatable ramp 38, and the selected item is guided by the rotatable ramp 38 into the corresponding delivery ramp 40 on the selected side, which in turn guides the selected item into the corresponding dispensing slot 32 on the selected side.

The multi-sided vending machine 10 also contains a memory 50 for storing product information 52 including images corresponding to products that are shown on the display panels 20 and also including price information for each product. The memory 50 also includes advertising data 54 that is used for showing advertisements when no customer is located nearby the multi-sided vending machine 10.

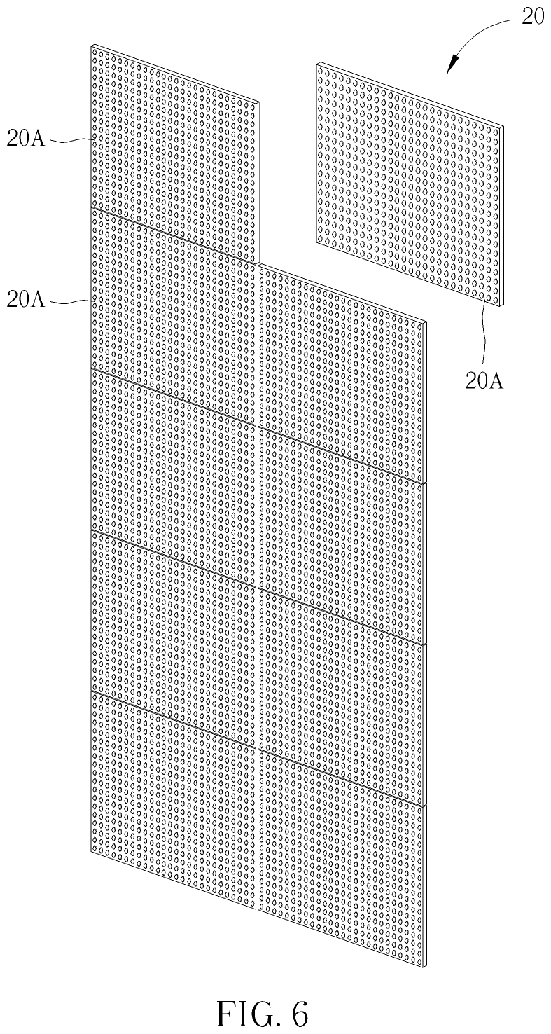

Please refer to FIG. 6. FIG. 6 illustrates creating a display panel 20 of the plurality of display panels 20 by joining many smaller displays 20A together. As is known in the art, using a combination of smaller displays 20A can allow more flexibility and a less expensive design when building display panels 20. This type of modular design using the smaller displays 20A can be used for different sides of the multi-sided vending machine 10. As shown in FIG. 6, ten different smaller displays 20A are joined together to create the display panel 20.

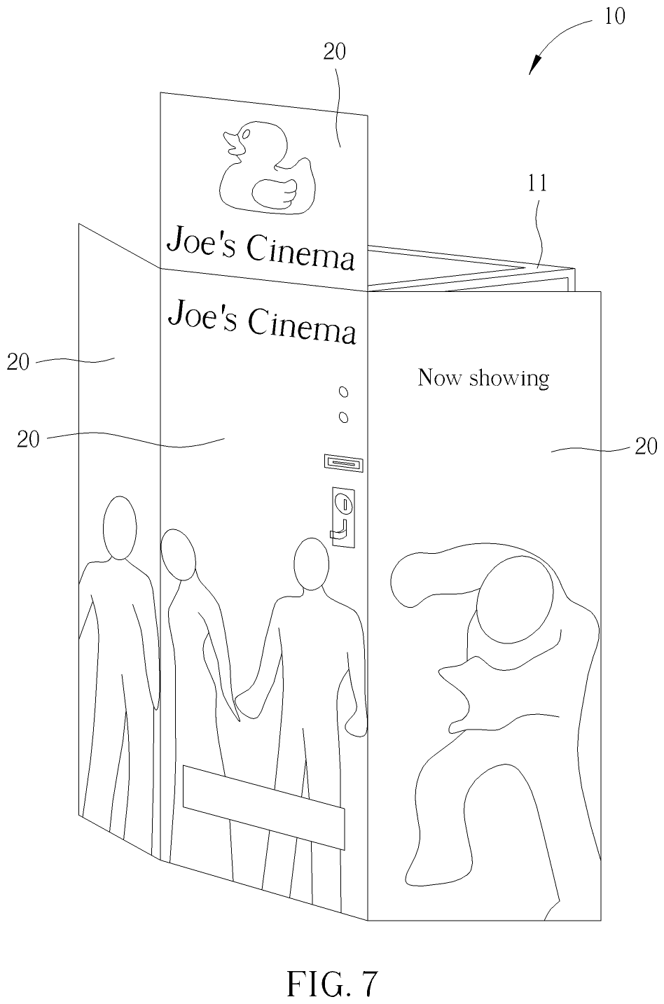

Please refer to FIG. 7. FIG. 7 illustrates rotating multiple display panels 20 of the plurality of display panels 20 toward a same side in order to create a larger advertising space with the display panels 20. When the display panels 20 are rotated, it is possible to see a housing 11 of the multi-sided vending machine 10 that serves as the structure of the multi-sided vending machine 10 upon which all of the display panels 20 are installed. As shown in FIG. 7 four different display panels 20 are rotated toward the same side in order to make a larger advertising space. These four different display panels 20 include display panels 20 from three different lateral sides of the multi-sided vending machine 10 as well as a display panel 20 from the top of the multi-sided vending machine 10. Display panels 20 from sides of the multi-sided vending machine 10 that are not currently being used for selling items can be rotated away from the housing 11 of the multi-sided vending machine 10 in order to create larger advertising spaces. In FIG. 7, the lower-middle display panel 20 is still installed on the housing 11 of the multi-sided vending machine 10, and this lower-middle display panel 20 can still be used for selling items on that side of the multi-sided vending machine 10.

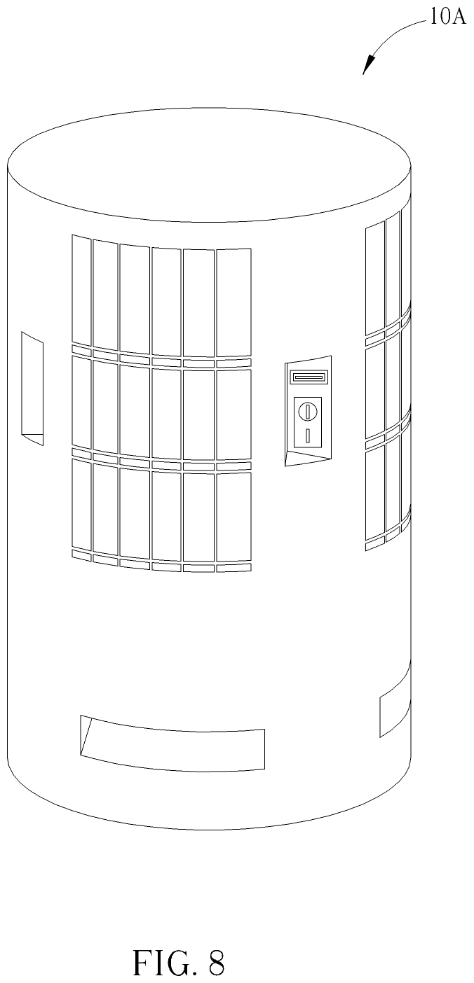

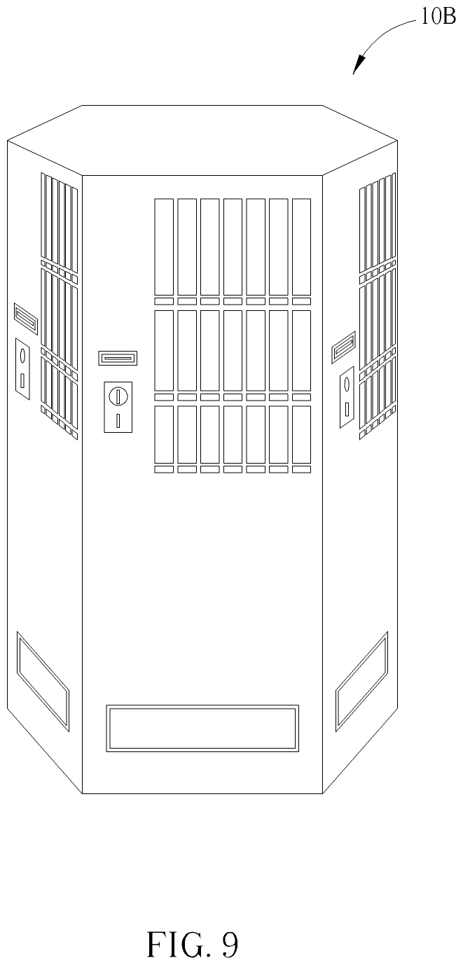

Please refer to FIG. 8 and FIG. 9. FIG. 8 illustrates a multi-sided vending machine 10A having a cylindrical shape according to another embodiment of the present invention. FIG. 9 illustrates a multi-sided vending machine 10B having a hexagonal prism shape according to yet another embodiment of the present invention. Any three dimensional shape can be used for creating the multi-sided vending machine 10 so long as the multi-sided vending machine 10 contains multiple display panels 20, multiple bill acceptors 26 and coin acceptors 28, and multiple dispensing slots 32 disposed on outer surfaces of different sides of the multi-sided vending machine 10.

The present invention uses more than one side of the multi-sided vending machine 10 for displaying and selling items. The multi-sided vending machine 10 allows sellers to use more area for displaying items being sold as compared to a traditional vending machine. Furthermore, a larger number of different items can potentially be sold through the multi-sided vending machine 10 since more different items can be displayed on the different sides of the multi-sided vending machine 10 compared to just using a single side of a traditional vending machine. Multiple customers can also buy items from the multi-sided vending machine 10 at the same time since different customers can interact with the multi-sided vending machine 10 for making purchases simultaneously through different sides of the multi-sided vending machine 10. This can reduce the wait experienced by potential customers and shorten the lines of people waiting to make a purchase through the multi-sided vending machine 10. Thus, the multi-sided vending machine 10 can increase sales for a vending machine operator while at the same time not requiring an increased footprint for area needed to install the multi-sided vending machine 10. Advertising revenue can also bring additional profit to vending machine operators.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-sided vending machine, comprising:
a housing;
a product storage compartment disposed within the housing, the product storage compartment storing items for sale;
a plurality of displays disposed outside the housing, each display of the plurality of displays being located on a different side of the housing, wherein the displays show images corresponding to the items for sale;
a user interface receiving instructions from a customer to purchase a selected item of the items for sale through a selected side of the multi-sided vending machine;
a plurality of money acceptors, each money acceptor of the plurality of money acceptors being located on a different side of the housing, a money acceptor of the plurality of money acceptors located on the selected side receiving money used to pay for the selected item;
a plurality of dispensing slots, each dispensing slot of the plurality of dispensing slots being located on a different side of the housing, wherein a dispensing slot of the plurality of dispensing slots located on the selected side dispenses the selected item to the customer after the selected item is purchased;
a rotatable ramp disposed within the housing above the plurality of dispensing slots and rotatable toward any of the different sides of the housing, the rotatable ramp rotating toward the selected side and guiding the selected item into the dispensing slot located on the selected side;
a motor turning the rotatable ramp toward the selected side when the selected item is purchased from the selected side; and
a controller controlling operation of the multi-sided vending machine, controlling the motor to turn the rotatable ramp toward the selected side, and controlling the product storage compartment to release the selected item when the selected item is purchased from the selected side.

2. The multi-sided vending machine of claim 1, further comprising a plurality of delivery ramps disposed within the housing above the plurality of dispensing slots and below the rotatable ramp, each delivery ramp of the plurality of delivery ramps corresponding to one dispensing slot of the plurality of dispensing slots, a delivery ramp of the plurality of delivery ramps located on the selected side guiding the selected item into the dispensing slot located on the selected side after receiving the selected item from the rotatable ramp.

3. The multi-sided vending machine of claim 1, wherein the plurality of displays are light-emitting diode arrays.

4. The multi-sided vending machine of claim 1, further comprising a plurality of touch panels formed over the plurality of displays, the plurality of touch panels receiving touch input from the customer and providing this touch input to the user interface.

5. The multi-sided vending machine of claim 1, wherein the money acceptors comprise bill acceptors and coin acceptors.

6. The multi-sided vending machine of claim 1, further comprising a memory storing product data related to the items for sale and storing advertisement data.

7. The multi-sided vending machine of claim 6, further comprising a plurality of sensors, each sensor of the plurality of sensors being located on a different side of the housing, the plurality of sensors detecting when the customer comes near the multi-sided vending machine, wherein the controller controls the plurality of displays to stop showing advertisements and to show images corresponding to the items for sale when the customer comes near the multi-sided vending machine.

8. The multi-sided vending machine of claim 6, further comprising a plurality of cameras, each camera of the plurality of cameras being located on a different side of the housing, the plurality of cameras detecting when the customer comes near the multi-sided vending machine, wherein the controller controls the plurality of displays to stop showing advertisements and to show images corresponding to the items for sale when the customer comes near the multi-sided vending machine.

9. The multi-sided vending machine of claim 6, wherein multiple displays of the plurality of displays are used in conjunction with one another to create a large advertisement.

10. The multi-sided vending machine of claim 1, wherein the housing has the shape of a rectangular prism, and the plurality of displays, the plurality of money acceptors, and the plurality of dispensing slots are located on multiple lateral sides of the rectangular prism.

11. A method of selling items for sale through a multi-sided vending machine, the method comprising:
receiving, through a user interface of the multi-sided vending machine, instructions from a customer to purchase a selected item of items for sale through a selected side of the multi-sided vending machine, the multi-sided vending machine comprising:
a housing;
a product storage compartment disposed within the housing, the product storage compartment storing the items for sale;
a plurality of displays disposed outside the housing, each display of the plurality of displays being located on a different side of the housing, wherein the displays show images corresponding to the items for sale;
a plurality of money acceptors, each money acceptor of the plurality of money acceptors being located on a different side of the housing, a money acceptor of the plurality of money acceptors located on the selected side receiving money used to pay for the selected item;
a plurality of dispensing slots, each dispensing slot of the plurality of dispensing slots being located on a different side of the housing, wherein a dispensing slot of the plurality of dispensing slots located on the selected side dispenses the selected item to the customer after the selected item is purchased;
a rotatable ramp disposed within the housing above the plurality of dispensing slots and rotatable toward any of the different sides of the housing, the rotatable ramp rotating toward the selected side and guiding the selected item into the dispensing slot located on the selected side; and
a motor turning the rotatable ramp toward the selected side when the selected item is purchased from the selected side; and
controlling the motor to turn the rotatable ramp toward the selected side and controlling the product storage compartment to release the selected item onto the rotatable ramp and down the dispensing slot located on the selected side when the selected item is purchased from the selected side.

12. The method of claim 11, wherein a plurality of delivery ramps are disposed within the housing above the plurality of dispensing slots and below the rotatable ramp, each delivery ramp of the plurality of delivery ramps corresponding to one dispensing slot of the plurality of dispensing slots, a delivery ramp of the plurality of delivery ramps located on the selected side guiding the selected item into the dispensing slot located on the selected side after receiving the selected item from the rotatable ramp.

13. The method of claim 11, wherein the plurality of displays are light-emitting diode arrays.

14. The method of claim 11, further comprising receiving touch input from the customer through a plurality of touch panels formed over the plurality of displays, the touch input being provided to the user interface.

15. The method of claim 11, wherein the money acceptors comprise bill acceptors and coin acceptors.

16. The method of claim 11, further comprising storing product data related to the items for sale and storing advertisement data in a memory of the multi-sided vending machine.

17. The method of claim 16, wherein the multi-sided vending machine further comprises a plurality of a plurality of sensors, each sensor of the plurality of sensors being located on a different side of the housing, and the method further comprises:
detecting with the plurality of sensors when the customer comes near the multi-sided vending machine; and
controlling the plurality of displays to stop showing advertisements and to show images corresponding to the items for sale when the customer comes near the multi-sided vending machine.

18. The method of claim 16, wherein the multi-sided vending machine further comprises a plurality of a plurality of cameras, each camera of the plurality of cameras being located on a different side of the housing, and the method further comprises:
detecting with the plurality of cameras when the customer comes near the multi-sided vending machine; and
controlling the plurality of displays to stop showing advertisements and to show images corresponding to the items for sale when the customer comes near the multi-sided vending machine.

19. The method of claim 16, wherein multiple displays of the plurality of displays are used in conjunction with one another to create a large advertisement.

20. The method of claim 11, wherein the housing has the shape of a rectangular prism, and the plurality of displays, the plurality of money acceptors, and the plurality of dispensing slots are located on multiple lateral sides of the rectangular prism.
